(19) United States
(12) Patent Application Publication
(10) Pub. No.: US 2005/0207564 A1
(43) Pub. Date: Sep. 22, 2005

(54) Low current telephone power line unit

(76) Inventor: Joseph Barkan, Rishon-LeZion (IL)

Correspondence Address: DANIEL J SWIRSKY, PO BOX 2345, BEIT SHEMESH, 99544, IL

(21) Appl. No.: 10/792,387

(22) Filed: Mar. 4, 2004

(51) Int. Cl. H04M 1/00

(52) U.S. Cl. 379/395.01

(57) ABSTRACT

A digital telephone includes a connector to a telephone line and a unit operative with current provided on the telephone line to minimally distort high amplitude voice signals during low current operation.

### FIELD OF THE INVENTION

The present invention relates to telephones generally and to telephone operation in the presence of low line current in particular.

### BACKGROUND OF THE INVENTION

Telephones are well-known in the art. They are typically a combination of analog and digital elements with the trend, over the years, to reducing the number of analog elements. Digital elements require a steady source of power and thus, digital phones typically plug into a power socket near their location. This is especially true for wireless telephones.

Unfortunately, power supplies occasionally are cut, at which point, most digital phones are not operative. There is a trend in digital phones to enable at least minima telephone operation during power cuts, using the 50V power that the central office of the telephone system supplies.

The central office has a predefined amount of power which must suffice for the telephones connected to it. To ensure that the system works during power cuts, the telephone companies typically specify a desired DC impedance for an OFF-HOOK state (i.e. for when a user picks up the telephone headset. In North America, according to TIA-EIA-470B, the voltage drop across the telephone at 20 mA should be less than or equal to 6V. This voltage drop must be divided between the analog activity of the telephone and the digital activity performed by a digital signal processor (DSP) providing the digital operation of the digital telephone.

DSPs take a fixed amount of power, which must be provided to them during a power cut, leaving the rest of the power to handle the voice signals. As a result, a digital telephone typically cannot easily handle high voltage audio signals (3 dBm is typically the maximum allowed amplitude), such as occur when the speaker shouts. The result is a distorted voice signal. This is shown in FIG. 1, to which reference is now made. As can be seen, the negative dips of the periodic signal are cut, giving the signal a flattened bottomlook. The person listening to this will hear a distorted voice signal.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a graphical illustration of a distorted voice signal;

FIG. 2 is a block diagram illustration of a power line unit, constructed and operative in accordance with the present invention;

FIG. 3 is a graphical illustration of the voice signal produced by the unit of FIG. 2;

FIG. 4A is a circuit diagram illustration of a distortion minimizer forming part of the unit of FIG. 2;

FIG. 4B is a circuit diagram illustration of a voltage maintainer and of a hold and transmit amplifier forming part of the unit of FIG. 2; and

FIG. 5 is a circuit diagram illustration of an alternative embodiment of the unit of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

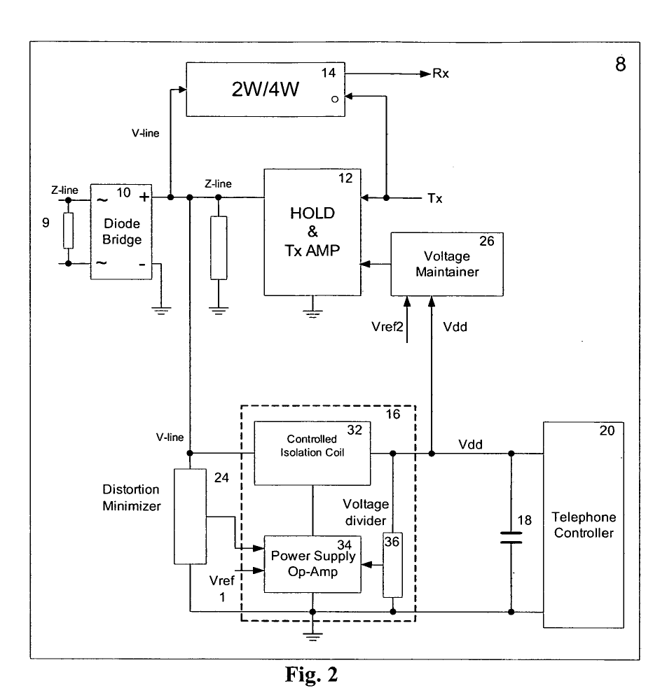

Reference is now made to FIG. 2, which illustrates a basic power line circuit for a digital telephone 8 with two additional units, constructed and operative in accordance with the present invention. The basic power line circuit may operate when there is no main power and the only power available is from a telephone line 9. To this end, it may comprise a diode bridge 10, a hold and transmit amplifier 12, a 2 wire to 4 wire (2W/4W) conversion unit 14, a voltage regulator 16, an output capacitor 18 and a digital telephone controller 20. To this, the present invention may add a low current, voice signal maintainer comprising a distortion minimizer 24 and a voltage maintainer 26.

Briefly, diode bridge 10 may correct the arbitrary polarity of the signal on telephone line 9 to that which telephone controller 18 may require. Hold and transmit amplifier 12 may hold line 9 when the user takes telephone 8 off-hook and may amplify and transmit the user's voice signals. In telephony, “transmission” (Tx) indicates signals produced by the user (on a headset microphone or a box microphone) and “reception” (Rx) indicates signals received from telephone line 9 (and provided to a headset speaker or a box speaker).

2W/4W conversion unit 14 may convert between the two wire format of telephone line 9 and the four wire format of telephone 8 and may provide voice signals for the user to hear, from both telephone line 9 and feedback of his own voice to be transmitted. Voltage regulator 16 may act as a power supply, controlling and regulating the voltage (a supply voltage Vdd) to telephone controller 20. In the present invention, voltage regulator 16 may ensure a 3V supply voltage at 10 mA.

Voltage regulator 16 may comprise a controlled isolation coil 32, a power supply operational amplifier (op-amp) 34 and a voltage divider 36. Isolation coil 32 may be a high impedance element connected before telephone controller 20. Due to its high impedance to audio frequencies, isolation coil 32 may generally isolate the telephone line from noise that is generated in the digital side by telephone controller 20. Isolation coil 32 may also convert the voltage Vline (comprised of DC (direct current) and audio signals) to a direct 3V DC signal.

Op-amp 34 may act as a feedback controller to isolation coil 32, measuring the level of supply Vdd and changing the impedance of isolation coil 32 to maintain the level of supply Vdd at the desired input level, such as 3V@10 mA. Voltage divider 36 may be connected between the output of isolation coil 32 and ground and may provide op-amp 34 with a voltage proportional to Vdd.

Output capacitor 18 may be a power supply output capacitor that may filter the voltage and may hold the energy, for the digital circuit, during line disconnect (such as during—Hook flash and pulse dialing).

As mentioned hereinabove, during power cuts, there may be distortions of the voice signal due to the lack of extra power. These distortions may be unpleasant for the user to hear. In accordance with a preferred embodiment of the present invention, units 24 and 26 may be added to the power line circuit to minimize the affect of the distortions.

Applicant has realized that isolation coil 32 should not operate in the presence of high audio levels, as it causes the distortions. Applicant has further realized that, in this situation, output capacitor 18, rather than isolation coil 32, may supply the 3V power to telephone controller 20.

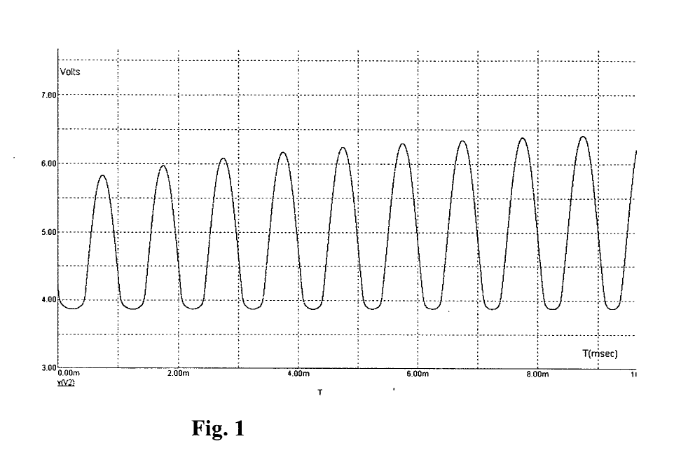

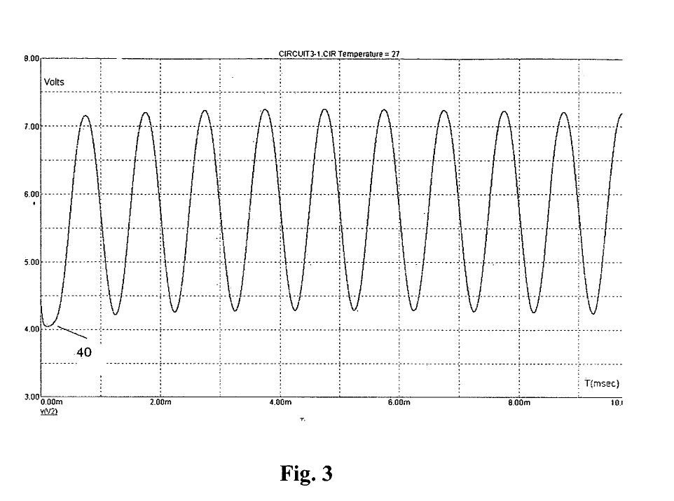

Distortion minimizer 24 may sense the presence of high amplitude signals, which may come when a user shouts and may reduce the current flowing through isolation coil 32. This may increase the voltage drop on isolation coil 32, which, in turn, may reduce the distortion. FIG. 3, to which reference is now made, shows the audio signal of FIG. 1 but as output of the power line circuit of the present invention. As can be seen, the audio signal is a relatively clean sine wave. Only the first negative cycle, labeled 40, may suffer from distortion.

Unfortunately, when distortion minimizer 24 may operate for too long, the power supply voltage Vdd may start to drop, possibly to the point where telephone controller 20 may reset itself, which, in turn, may disconnect the telephone call, an undesirable result.

Voltage maintainer 26, which may monitor the 3V supply to telephone controller 20, may begin operation when the power supply drops significantly and may raise the level of supply voltage Vdd. For example, voltage maintainer 26 may raise the voltage level of amplifier 12 such that the voltage drop on telephone line 9 may be higher than specified. For example, if the specified voltage drop is 6V, voltage maintainer 26 may raise the voltage drop by 1-1.5V. While this voltage drop may be above that which is specified, it is not expected to last for a long time, since it may be present only when a speaker is speaking loudly and such does not happen for long periods of time. Moreover, it occurs only during a power cut, a not very common occurrence.

It will be appreciated that the present invention may increase the dynamic range of the audio signals while maintaining a stable power supply to telephone controller 20.

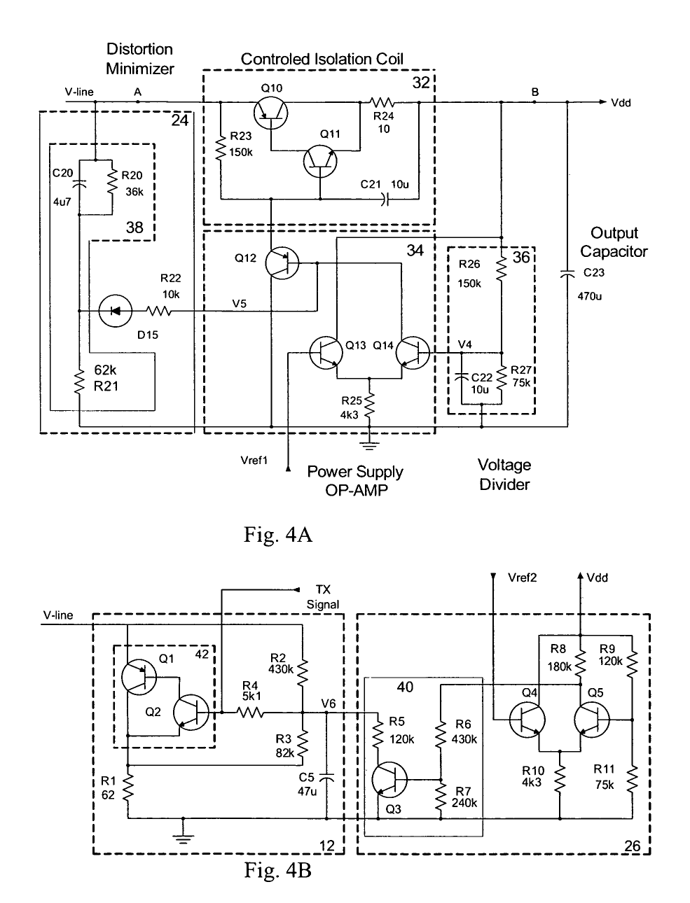

Reference is now made to FIGS. 4A and 4B, which together illustrate one embodiment, in circuit format, the elements of the power line circuit of the present invention. Since many of the elements are known, they will not be described in detail, it being understood that persons skilled in the art know how to build such elements.

In FIG. 4A, isolation coil 32 may be connected between a point A (the line input) and a point B (the power supply output) and may comprise two transistors Q10 and Q11, two resistors R23 and R24 and a capacitor C21. Transistors Q10 and Q11 may be connected as high current gain NPN transistors. The voltage drop on controlled isolation coil 32 (which is equivalent to the impedance of the coil) may be controlled by the current flows through resistor R23. The equivalent inductance of the circuit is:
L=R23*R24*C21

Voltage divider 36 may be connected between point B and ground and may comprise two resistors R26 and R27 in series, connected in parallel with the output capacitor, here labeled C23. In addition, voltage divider 36 may comprise a capacitor C22 connected in parallel with resistor R27. The voltage on resistor R27 and capacitor C22, labeled V4, may be the input to op-amp 34.

Op-amp 34 may comprise three transistors Q12, Q13 and Q14 and a resistor R25. Transistors Q13 and Q14 may be connected as an operational amplifier, as is known in the art, and transistor Q12 may act as an output driver. The base of transistor Q14 may receive V4, a sampled version of power supply Vdd, and the base of transistor Q13 may receive a reference voltage Vref1 The Op-amp of transistors Q13 and Q14 may compare the two inputs and, in response, may control the current through driver Q12 which, in turn, may control the voltage drop across isolation coil 32. For example, if power supply Vdd goes high, transistor Q14 may conduct more, which may cause transistor Q12 to conduct more, which may increase the voltage drop across isolation coil 32, which may reduce power supply Vdd back towards the desired 3V value.

In accordance with a preferred embodiment of the present invention, transistor Q12 may also operate as an “OR” function and may have a second input, controlled by distortion minimizer 24, which may be connected to its base,

In this embodiment, distortion minimizer 24 may receive the Vline signal and may comprise a voltage divider 38 (a capacitor C20 and a resistor R20 in parallel, connected in series with a resistor R21), a diode D16 and a resistor R22.

Capacitor C20 in voltage divider 38 may emphasize the AC signals over the DC level. Thus, in the presence of high AC amplitude in the Vline signal, that may cause isolation coil 32 not to behave like a coil and to load the AC signal on telephone line 9, diode D15 may conduct. This, in turn, may increase the current through driver Q12. By increasing the current and by bypassing the op-amp of transistors Q13 and Q14, transistors Q10 and Q11 of isolation coil 32 may conduct less, thereby not loading the AC signals. The lowered voltage across isolation coil 32 may temporarily not reduce power supply Vdd because output capacitor C23 may store sufficient charge to temporarily sustain power supply Vdd.

However, as the stored charge may be utilized, the voltage level of power supply Vdd may decrease. If it decreases below 2.5V, telephone controller 20 may reset itself, an undesired action. Voltage maintainer 26 (FIG. 4B) may temporarily raise the voltage of the connection to input telephone line 9 in order to raise power supply Vdd.

Voltage maintainer 26 may receive power supply Vdd and a second reference voltage Vref2 and may produce a signal V6 to hold and transmit amplifier 12. If desired, second reference voltage Vref2 may be the same signal as the first reference voltage Vref1. Voltage maintainer 26 may comprise three transistors Q3, Q4 and Q5 and 7 resistors R5, R6, R7, R8, R9, R10 and R11. Transistors Q4 and Q5 may be connected as an operational amplifier. Transistor Q3 may form the basis of an output stage 40 that operates as a current sink.

Resistors R9 and R11 may provide a sampled version of power supply Vdd to one input of the operational amplifier (e.g. to the base of transistor Q5). The second input of the operational amplifier, the base of transistor Q4, may be connected to reference voltage Vref2.

As power supply Vdd may start to drop, transistor Q5 may conduct less and the voltage at the collector of transistor Q5 may rise. The collector voltage of transistor Q5 may be fed to output stage 40 through resistor R6. As the collector voltage of transistor Q5 rises, transistor Q3 of output stage 40 may start to sink more current. Resistor R5 may set the lower limit of the current that transistor Q3 may sink and resistors R6 and R7 may set the bias and gain of output stage 40.

Hold and transmit amplifier 12 may receive an output V6 of current sink 40. Amplifier 12 may be based on a “coil” 42 formed of two transistors Q1 and Q2 that may operate as an NPN transistor with high current gain. Amplifier 12 may additionally comprise four resistors R1, R2, R3 and R4 and a capacitor C5.

The transmitted signal Tx may be injected directly to the base of transistor Q2. Resistor R4 may route the audio signal via capacitor C5, thereby to reduce any shorting of the signal to ground. Since the value of resistor R4 may be small compared to the values of resistors R2 and R3 and since the base current of transistor Q2 may be small, due to the high gain configuration of transistors Q1 and Q2, resistor R4 generally does not effect the DC bias or the equivalent inductance of the circuit.

Resistors R2 and R1 and capacitor C5 may set the equivalent inductance of the circuit as:
L=R2*R1*C5.

Resistors R2 and R3 may set a minimum DC voltage across coil 42 to be:
V=Vbe*[1+(R2)/(R3)]

If power supply Vdd starts to drop, then transistor Q3 of current sink 40 may start to conduct, as described hereinabove, which, in turn, may change the value of the impedance that resistor R2 may see. For example, when transistor Q3 may be in a cutoff state, resistor R2 may see the impedance of resistor R3, while, when transistor Q3 may be in saturation (i.e. when power supply Vdd starts to drop and transistor Q3 may be sinking current, the equivalent impedance may be the impedance of resistor R3 in parallel with resistor R5. This temporary impedance may temporarily raise the voltage drop across amplifier 12 and may raise the level of incoming voltage Vline.

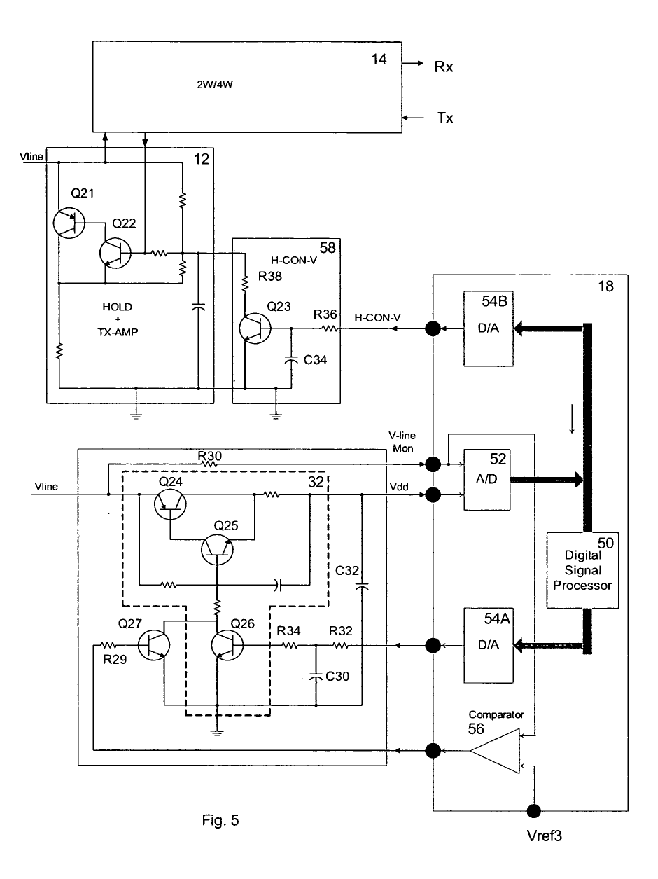

Reference is now made to FIG. 5, which illustrates a second embodiment, constructed and operative in accordance with the present invention, in which distortion minimizer 24 and voltage maintainer 26 may be implemented using the capabilities of telephone controller 18. In particular, the DX 36 family of DSP chips, commercially available from The DSP Group Ltd. of Israel, include in them both a digital signal processor 50 and peripheral analog elements, such as analog-to-digital (A/D) converters 52 and digital-to-analog (D/A) converters 54, analog comparators 56 and other simple analog devices. Both types of elements may be utilized to implement distortion minimizer 24 and voltage maintainer 26.

In this embodiment, distortion minimizer 24 may comprise analog elements and digital elements. Its analog elements may comprise a control transistor Q27, a resistor R29 and comparator 56 (within telephone controller 18). Its digital elements may comprise A/D converter 52 and D/A converter 54A.

For distortion minimizer 24, the voltage Vline of telephone line 9 may be provided, through a resistor R30, to telephone controller 18. The resultant signal, within the voltage range that telephone controller 18 may read, is labeled Vline-Mon. Power supply Vdd, output of isolation coil 32, may also be provided to telephone controller 18. Both signals may be provided to A/D converter 52 and the resultant digital signals may be provided to processor 50 for processing. Moreover, the Vline-Mon signal may be fed to comparator 56 for detecting the high audio amplitude, as described hereinbelow.

Processor 50 may measure the strength of power supply Vdd and may determine an appropriate voltage level (exported through D/A 54A as Vfdbk) to change the impedance of isolation coil 32 accordingly. Transistor Q26 may receive the feedback voltage Vfdbk and may shift it from the level at which telephone controller 18 operates to an appropriate analog level to affect the flow of current through transistor Q26. In a normal mode, the changing current flow changes the impedance of isolation coil 32.

In addition, transistor Q26 may operate with transistor Q27 in a “wired or” function, as follows. In the normal mode, transistor Q27 may not operate. However, comparator 56 may compare the voltage Vline of the telephone line (the DC and the AC voltages) with a reference voltage Vref3 (which may be the same as Vref1 or a different signal) and may issue a positive signal whenever there is a high negative peak in voltage Vline. The positive signal may saturate transistor Q27, which may enable it to dominate transistor Q26. Moreover, conduction of transistor Q27 may discharge capacitor C32 which in turn, may cause transistors Q24 and Q25 of isolation coil 32 not to conduct.

In this embodiment, voltage maintainer 26 may comprise a holding coil voltage controller 58, A/D converter 52 and D/A converter 54B. For voltage maintainer 26, processor 50 may monitor power supply Vdd using A/D 52. When power supply Vdd may start to drop, processor 50 may increase the output of D/A 54B to controller 58.

Holding coil voltage controller 58 may comprise a transistor Q23, two resistors R36 and R38 and a capacitor C34. The increased voltage from D/A 54B may cause transistor Q23 to conduct more which, in turn, may increase the voltage drop across holding coil and transmit amplifier 12 in a manner similar to that explained hereinabove. Resistor R36 may form a base resistor and capacitor C34 may filter the D/A output.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A digital telephone comprising:
a connector to a telephone line; and
a low current voice signal maintainer to minimize high amplitude distortion of a voice signal during low current operation of said telephone line.

2. The telephone according to claim 1 and wherein said voice signal maintainer comprises a distortion minimizer to minimize said high amplitude distortion and a voltage maintainer to maintain a supply output of a power supply within a predefined voltage range when said distortion minimizer is activated.

3. The telephone according to claim 2 and wherein said distortion minimizer comprises a comparator to reduce current through an isolation coil of said power supply in the presence of high AC amplitude voltage in said voice signals.

4. The telephone according to claim 2 and wherein said voltage maintainer comprises a comparator to compare said supply output with a reference voltage and to provide a control signal to a holding coil and transmit amplifier when said supply output drops below a predefined voltage level.

5. The telephone according to claim 2 and wherein said distortion minimizer comprises a diode, activatable in the presence of high AC amplitude voltage in said voice signal, to increase current through a control transistor thereby to reduce current through an isolation coil of said power supply.

6. The telephone according to claim 2 and wherein said voltage maintainer comprises a digital to analog converter receiving control signals from a digital telephone controller, said control signals responding to any dropping of the voltage level of said power supply occurring when said distortion minimizer is activated.

7. A digital telephone comprising:
a connector to a telephone line; and
a unit operative with current provided on said telephone line to minimally distort high amplitude voice signals during low current operation.

8. The telephone according to claim 7 and wherein said unit comprises a distortion minimizer to minimize high amplitude distortion of said voice signals and a voltage maintainer to maintain a supply output of a power supply within a predefined voltage range when said distortion minimizer is activated.

9. The telephone according to claim 8 and wherein said distortion minimizer comprises a comparator to reduce current through an isolation coil of said power supply in the presence of high AC amplitude voltage in said voice signals.

10. The telephone according to claim 8 and wherein said voltage maintainer comprises a comparator to compare said supply output with a reference voltage and to provide a control signal to a holding coil and transmit amplifier when said supply output drops below a predefined voltage level.

11. The telephone according to claim 8 and wherein said distortion minimizer comprises a diode, activatable in the presence of high AC amplitude voltage in said voice signal, to increase current through a control transistor thereby to reduce current through an isolation coil of said power supply.

12. The telephone according to claim 8 and wherein said voltage maintainer comprises a digital to analog converter receiving control signals from a digital telephone controller, said control signals responding to any dropping of the voltage level of said power supply occurring when said distortion minimizer is activated.

13. A method comprising:
minimally distorting high amplitude voice signals during low current operation of a digital telephone.

14. The method according to claim 13 and wherein said minimally distorting comprises minimizing high amplitude distortion of said voice signals and maintaining a supply output of a power supply within a predefined voltage range when said minimizing occurs.

15. The method according to claim 14 and wherein said minimizing comprises reducing current through an isolation coil of said power supply in the presence of high AC amplitude voltage in said voice signals.

16. The method according to claim 14 and wherein said maintaining comprises comparing said supply output with a reference voltage and providing a control signal to a holding coil and transmit amplifier when said supply output drops below a predefined voltage level.
